(19) United States
(12) Patent Application Publication
(10) Pub. No.: US 2022/0192143 A1
(43) Pub. Date: Jun. 23, 2022

(54) CAT SAND ADDITIVES

(71) Applicant: MY CO., LTD, Gwangju-si (KR)

(72) Inventor: Pyo SONG, Seoul (KR)

(73) Assignee: MY CO., LTD

(21) Appl. No.: 17/387,378

(22) Filed: Jul. 28, 2021

(30) Foreign Application Priority Data
Dec. 17, 2020 (KR) 10-2020-0177090

(51) Int. Cl. A01K 1/015; B01J 20/18; B01J 20/12; B01J 20/24; B01J 20/30

(52) U.S. Cl. CPC A01K 1/0155; B01J 20/18; B01J 20/12; A01K 1/0154; B01J 20/3021; B01J 20/3078; B01J 20/3085; B01J 20/24

(57) ABSTRACT

Disclosed is a cat litter additive including at least one selected from a first additive made by pulverizing, mixing and sintering zeolite and rice bran and a fifth additive made by pulverizing, mixing and sintering zeolite, bentonite, and rice bran, so that the cat litter additive has excellent antimicrobial and odor-removing functions.

### CROSS REFERENCE TO RELATED APPLICATION OF THE INVENTION

The present application claims the benefit of Korean Patent Application No. 10-2020-0177090 filed in the Korean Intellectual Property Office on Dec. 17, 2020, the entire contents of which are incorporated herein by reference.

### BACKGROUND OF THE INVENTION

### Field of the Invention

The present invention relates to a cat litter additive, and more particularly, to a cat litter additive that is capable of removing bacteria and odor from a cat litter in which cat feces and urine are contained when added to the cat litter.

### Background of the Related Art

Cats have a habit of burying their feces and urine into sand. Means for treating the cat feces and urine using such their habit is commercialized as a ‘cat litter’.

The cat litter is made of silica litter having excellent capability of absorbing feces and urine or bentonite litter made by pulverizing bentonite capable of solidifying feces and urine.

In this case, the silica litter has no solidifying force so that the cat feces and urine are not changed to a solid form, thereby failing to eliminate the odor generated from the cat feces and urine. In addition, the silica litter has no antimicrobial function, thereby causing various diseases due to the bacteria contained in the cat feces and urine.

The bentonite litter has a high solidifying force, but has keen particle surfaces and generates a lot of dust. In addition, the bentonite litter has no disinfecting or antimicrobial function, thereby causing a high risk of getting diseases due to the bacteria contained in the cat feces and urine.

Like this, the existing cat litter is focused just on the absorption and solidification of the feces and urine, so that the existing cat litter does not have any function of eliminating the odor and bacteria from the feces and urine, thereby failing to provide a sanitary situation for both of the cat and the surrounding environment of the cat.

### SUMMARY OF THE INVENTION

Accordingly, the present invention has been made in view of the above-mentioned problems occurring in the related art, and it is an object of the present invention to provide a cat litter additive that is capable of eliminating the bacteria contained in cat feces and urine to protect a cat from diseases.

It is another object of the present invention to provide a cat litter additive that is capable of making use of a natural plant-based antimicrobial substance to help a cat healthy.

It is yet another object of the present invention to provide a cat litter additive that is capable of removing odor from cat feces and urine.

To accomplish the above-mentioned objects, according to the present invention, there is provided a cat litter additive including at least one selected from a first additive made by pulverizing, mixing and sintering zeolite and rice bran and a fifth additive made by pulverizing, mixing and sintering zeolite, bentonite, and rice bran.

According to the present invention, desirably, the cat litter additive further may include at least one selected from a second additive made by submerging the first additive in a plant-based natural antimicrobial substance, a third additive made by submerging the first additive in a plant-based natural antimicrobial agent, a fourth additive made by submerging the first additive in a photocatalyst, a sixth additive made by submerging the fifth additive in the plant-based natural antimicrobial substance, a seventh additive made by submerging the fifth additive in the plant-based natural antimicrobial agent, and an eighth additive made by submerging the fifth additive in the photocatalyst.

According to the present invention, desirably, the natural antimicrobial substance may include fennel and tinctoria leaf-based components.

According to the present invention, desirably, the natural antimicrobial substance may be made by the steps of: performing reflux extraction for the fennel and the tinctoria leaves through an extraction solvent to obtain a fennel extract liquid and a tinctoria leaf extract liquid; allowing the fennel extract liquid and the tinctoria leaf extract liquid to be subjected to filtering, condensing, and freeze drying to powder forms to obtain fennel extract powder and tinctoria leaf extract powder; dispersing the fennel extract powder and the tinctoria leaf extract powder into distilled water to obtain a fennel extract fraction and a tinctoria leaf extract fraction through an organic solvent; mixing the fennel extract fraction and the tinctoria leaf extract fraction and applying ultrasonic stimulation to the fennel extract fraction and the tinctoria leaf extract fraction to nanorize the fennel extract fraction and the tinctoria leaf extract fraction; and applying electrical stimulation to the nanorized fennel extract fraction and tinctoria leaf extract fraction.

According to the present invention, desirably, the plant-based natural antimicrobial agent may include the natural antimicrobial substance and at least one substance selected from sugar alcohol and dextrin.

### DETAILED DESCRIPTION OF THE EMBODIMENTS

A cat litter additive according to the present invention includes at least one selected from a first additive made by sintering zeolite and rice bran, a second additive made by submerging the first additive in a natural antimicrobial substance, a third additive made by submerging the first additive in a natural antimicrobial agent, a fourth additive made by submerging the first additive into a photocatalyst, a fifth additive made by sintering zeolite, bentonite, and rice bran, a sixth additive made by submerging the fifth additive in a natural antimicrobial substance, a seventh additive made by submerging the fifth additive in a natural antimicrobial agent, and an eighth additive made by submerging the fifth additive in a photocatalyst.

### Method for Making First Additive

The first additive is made through the following steps.

According to the present invention, a method for making the first additive includes the steps of pulverizing zeolite, pulverizing rice bran, mixing the pulverized zeolite and rice bran, and sintering the pulverized and mixed zeolite and rice bran.

1. Step of Pulverizing Zeolite

First, zeolite to be used for the cat litter additive according to the present invention is put and pulverized in a pulverizer. Through the pulverization, desirably, the zeolite has particles of sizes in the range of 1 to 10 mm.

2. Step of Pulverizing Rice Bran

Next, rice bran is put and pulverized in a pulverizer. Through the pulverization, desirably, the rice bran has particles of sizes in the range of 1 to 10 mm.

3. Mixing Step

The pulverized zeolite and rice bran are mixed with each other. Desirably, 50 to 100 parts by weight of the pulverized zeolite and 1 to 50 parts by weight of the pulverized rice bran are mixed with each other. Hereinafter, the pulverized zeolite and rice bran mixed with each other is referred to simply as ‘pulverized zeolite-rice bran mixture’.

4. Sintering Step

The pulverized zeolite-rice bran mixture, which is obtained in the mixing step, is sintered at a given set temperature. Desirably, the pulverized zeolite-rice bran mixture is sintered at a temperature of 400 to 800° C. for 30 to 120 minutes.

Hereinafter, the pulverized zeolite-rice bran mixture after being subjected to the sintering step is referred to simply as the ‘first additive’.

Through the sintering step, the rice bran is carbonized and thus binds to the surface of the zeolite. The carbonized rice bran removes odor from cat feces and urine as well as harmful bacteria contained therein.

The first additive made through the sintering step has particles of sizes in the range of 2 to 20 mm.

### Method for Making Fifth Additive

The fifth additive is made through the following steps.

According to the present invention, a method for making the fifth additive includes the steps of pulverizing zeolite, pulverizing bentonite, pulverizing rice bran, mixing the pulverized zeolite, bentonite, and rice bran with one another, and sintering the pulverized and mixed zeolite, bentonite, and rice bran.

1. Step of Pulverizing Zeolite

First, zeolite to be used for the cat litter additive according to the present invention is put and pulverized in a pulverizer. Through the pulverization, desirably, the zeolite has particles of sizes in the range of 1 to 10 mm.

2. Step of Pulverizing Bentonite

Next, bentonite to be used for the cat litter additive according to the present invention is put and pulverized in a pulverizer. Through the pulverization, desirably, the bentonite has particles of sizes in the range of 1 to 10 mm.

3. Step of Pulverizing Rice Bran

After that, rice bran is put and pulverized in a pulverizer. Through the pulverization, desirably, the rice bran has particles of sizes in the range of 1 to 10 mm.

4. Mixing Step

The pulverized zeolite, bentonite, and rice bran are mixed with one another. Desirably, 50 to 100 parts by weight of the pulverized zeolite, 50 to 100 parts by weight of the pulverized bentonite, and 1 to 50 parts by weight of the pulverized rice bran are mixed with one another. Hereinafter, the pulverized zeolite, bentonite, and rice bran mixed with one another is referred to simply as ‘pulverized zeolite-bentonite-rice bran mixture’.

5. Sintering Step

The pulverized zeolite-bentonite-rice bran mixture, which is obtained in the mixing step, is sintered at a given set temperature. Desirably, the pulverized zeolite-bentonite-rice bran mixture is sintered at a temperature of 400 to 800° C. for 30 to 120 minutes.

Hereinafter, the pulverized zeolite-bentonite-rice bran mixture after being subjected to the sintering step is referred to as the ‘fifth additive’.

Through the sintering step, the rice bran is carbonized and thus binds to the surface of the zeolite. The carbonized rice bran removes odor from feces and urine and harmful bacteria contained in the feces and urine.

The fifth additive made through the sintering step has particles of sizes in the range of 2 to 20 mm.

### Method for Making Natural Antimicrobial Substance

According to the present invention, a natural antimicrobial agent may include a natural antimicrobial substance. The natural antimicrobial substance may include fennel and tinctoria leaf extracts or fractions.

According to the present invention, a method for making the natural antimicrobial substance may include the steps of performing reflux extraction for cleaned and well-sorted fennel and tinctoria leaves through an extraction solvent to obtain extract liquids, allowing the extract liquids to be subjected to filtering, condensing, and freeze drying to a powder form, dispersing the powder into distilled water to obtain fractions through an organic solvent, mixing the fractions and applying ultrasonic stimulation to the fractions to nanorize the fractions, applying electrical stimulation to the nanorized natural plant components to allow the natural plant components to permeate one another, and heating and vacuum-drying the nanorized natural plant components to which the electrical stimulation is applied.

1. Step of Obtaining Extract Liquids

First, fennel and tinctoria leaves are cleaned and then subjected to reflux extraction for one hour two times using ethanol as an extraction solvent, respectively, thereby obtaining a fennel extract liquid and a tinctoria leaf extract liquid.

2. Powderization Step

Next, the fennel extract liquid and the tinctoria leaf extract liquid are filtered through a typical filtering method, and after the filtering, they are condensed through a rotary evaporator. After condensed, they are subjected to freeze drying and thus made to the power form. Like this, the fennel extract liquid and the tinctoria leaf extract liquid after being subjected to the powderization step are referred to simply as ‘fennel extract powder’ and ‘tinctoria leaf extract powder’.

3. Step of Obtaining Fractions

The distilled water is mixed to the fennel extract powder and the tinctoria leaf extract powder, respectively, to allow the extract powder to be dispersed thereinto. Next, an organic solvent is put into the extract powder dispersed into the distilled water to obtain a fennel extract fraction and a tinctoria leaf extract fraction.

According to the present invention, the fennel extract powder is dispersed into the distilled water to make an aqueous solution (hereinafter, referred to as an aqueous fennel extract) containing the fennel extract. In the same manner as above, the tinctoria leaf extract powder is dispersed into the distilled water to make an aqueous solution (hereinafter, referred to as an aqueous tinctoria leaf extract) containing the tinctoria leaf extract.

A weight ratio of the fennel extract powder to the distilled water is the same as of the tinctoria leaf extract powder to the distilled water. According to the present invention, a weight ratio of each powder to the distilled water is in the range of 1:1 to 1:10.

A weight ratio of the aqueous fennel extract to the aqueous tinctoria leaf extract is in the range of 1:0.1 to 1:5.

The organic solvent is put into the aqueous fennel extract to obtain the fennel extract fraction. In the same manner as above, the organic solvent is put into the aqueous tinctoria leaf extract to obtain a tinctoria leaf extract fraction.

Desirably, a weight ratio of the aqueous fennel extract to the organic solvent is in the range of 1:1.5 to 1:8. Further, a weight ratio of the aqueous tinctoria leaf extract to the organic solvent is in the range of 1:1.5 to 1:8.

The organic solvent comprises one or two kinds of substances selected from the group consisting of hexane, chloroform, ethylacetate, and butanol.

4. Nanorization Step

The fennel extract fraction and the tinctoria leaf extract fraction that are obtained in the step of obtaining the fractions are mixed with each other. After that, the mixture of the fennel extract fraction and the tinctoria leaf extract fraction is nanorized through ultrasonic stimulation. The ultrasonic stimulation is carried out at the frequency in the range of 35000 to 50000 Hz for three minutes, and next, the mixture is stabilized for two minutes. Such a process is repeatedly carried out 12 times. As a result, the nanorized fennel extract fraction and tinctoria leaf extract fraction can be obtained.

5. Electrical Stimulation Step

Next, electrical stimulation is applied to the nanorized fennel extract fraction and the nanorized tinctoria leaf extract fraction to allow the fractions to permeate one another. In this case, the electrical stimulation is carried out at a voltage of 80 to 110 V and a current of 50 to 65 mA for 10 to 30 minutes one time, and otherwise, it may be carried out at a voltage of 50 to 110 V and a current of 30 to 50 mA for 10 to 20 minutes two times. In this process, the nanorized fennel extract fraction may permeate the nanorized tinctoria leaf extract fraction, and contrarily, the nanorized tinctoria leaf extract fraction may permeate the nanorized fennel extract fraction.

6. Heating and Vacuum-Drying Step

After that, the fennel extract fraction and the tinctoria leaf extract fraction after being subjected to the electrical stimulation are heated at a temperature of 900 to 1,100° C. for 25 to 35 minutes, and next, they are subjected to vacuum-drying for seven hours, thereby obtaining the natural antimicrobial substance.

The manufactured natural antimicrobial substance has a specific structure in which the nanorized fennel extract fraction and the nanorized tinctoria leaf extract fraction permeate each other through ion reaction to thus break the cell membranes of bacteria, thereby optimizing antimicrobial activities. Also, the specific structure is advantageously safe for the cell membranes of animals.

Further, the natural antimicrobial substance is made by allowing the nanorized fennel extract fraction and the nanorized tinctoria leaf extract fraction to permeate each other, thereby providing a higher degree of binding affinity to portions to which effective antimicrobial components bind than the existing plant extract.

### Natural Antimicrobial Agent Containing Natural Antimicrobial Substance

According to the present invention, a natural antimicrobial agent may include only the natural antimicrobial substance as mentioned above or may include the natural antimicrobial substance as mentioned above and at least one substance selected from sugar alcohol and dextrin. The sugar alcohol may include at least one selected from the group consisting of sorbitol, xylitol, mannitol, erithritol, lactitol, and maltitol.

As the natural antimicrobial agent is made through the method for making the natural antimicrobial substance as mentioned above, the repeated explanation will be omitted below.

According to the present invention, the natural antimicrobial agent may contain 1 to 60 parts by weight of the natural antimicrobial substance, 4 to 20 parts by weight of the sorbitol, and 5 to 40 parts by weight of the maltitol.

According to the present invention, the maltitol and the sorbitol serve to interfere with the metabolism of strains and thus to kill bacteria. Further, the maltitol is converted into mannose, and the sorbitol into glycan like glucose. The converted glycan serves as a substance surrounding bacteria and viruses to have an influence on interaction between the bacteria or between the viruses and hosts, thereby suppressing the activities of the bacteria and viruses.

Also, the dextrin, sorbitol, and maltitol are permitted for use as food additives, so that they are not harmful to animals.

### Photocatalyst

According to the present invention, a photocatalyst may include water added thereto. According to the present invention, the photocatalyst may contain at least one selected from the group consisting of titanium phosphate, titanium dioxide, titanium, manganese, and manganese dioxide.

If the photocatalyst is put into water, reactive oxygen is generated from the water to thus remove the microorganisms harmful to cats, such as bacteria, fungi, viruses, and so on.

Also, the photocatalyst advantageously removes odor from the feces and urine.

### Method for Making Cat Litter Additive

According to the present invention, the cat litter additive may include at least one selected from first to eighth additives as will be discussed below.

So as to allow the sintered zeolite-rice bran to be submerged into the natural antimicrobial substance, the natural antimicrobial agent, and the photocatalyst, the natural antimicrobial agent and the photocatalyst are sprayed onto the sintered zeolite-rice bran, or the sintered zeolite-rice bran is immersed in the natural antimicrobial agent and the photocatalyst.

So as to allow the sintered zeolite-bentonite-rice bran to be submerged into the natural antimicrobial substance, the natural antimicrobial agent, and the photocatalyst, in the same manner as above, the natural antimicrobial agent and the photocatalyst are sprayed onto the sintered zeolite-bentonite-rice bran, or the sintered zeolite-bentonite-rice bran is immersed in the natural antimicrobial agent and the photocatalyst.

Hereinafter, the sintered zeolite-rice bran with no submersion in the natural antimicrobial substance, the natural antimicrobial agent, and the photocatalyst is defined as the first additive, the sintered zeolite-rice bran with the submersion in the natural antimicrobial substance is defined as the second additive, the sintered zeolite-rice bran with the submersion in the natural antimicrobial agent is defined as the third additive, and the sintered zeolite-rice bran with the submersion in the photocatalyst is defined as the fourth additive.

Further, the sintered zeolite-bentonite-rice bran with no submersion in the natural antimicrobial substance, the natural antimicrobial agent, and the photocatalyst is defined as the fifth additive, the sintered zeolite-bentonite-rice bran with the submersion in the natural antimicrobial substance is defined as the sixth additive, the sintered zeolite-bentonite-rice bran with the submersion in the natural antimicrobial agent is defined as the seventh additive, and the sintered zeolite-bentonite-rice bran with the submersion in the photocatalyst is defined as the eighth additive.

According to the present invention, the cat litter additive may include 1 to parts by weight of the first additive, 1 to 30 parts by weight of the second additive, and 1 to parts by weight of the third additive.

As described above, the cat litter additive according to the present invention can make use of the natural plant-based antimicrobial substance or the photocatalyst to remove the bacteria contained in the feces and urine, thereby protecting the cat from diseases and preventing the contact dermatitis caused by the existing chemical antimicrobial agent.

In addition, the cat litter additive according to the present invention can eliminate the odor from the feces and urine through the carbonated rice bran contained in the zeolite and the photocatalyst.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A cat litter additive comprising at least one selected from a first additive made by pulverizing, mixing and sintering zeolite and rice bran and a fifth additive made by pulverizing, mixing and sintering zeolite, bentonite, and rice bran.

2. The cat litter additive according to claim 1, further comprising at least one selected from a second additive made by submerging the first additive in a plant-based natural antimicrobial substance, a third additive made by submerging the first additive in a plant-based natural antimicrobial agent, a fourth additive made by submerging the first additive in a photocatalyst, a sixth additive made by submerging the fifth additive in the plant-based natural antimicrobial substance, a seventh additive made by submerging the fifth additive in the plant-based natural antimicrobial agent, and an eighth additive made by submerging the fifth additive in the photocatalyst.

3. The cat litter additive according to claim 2, wherein the natural antimicrobial substance comprises fennel and tinctoria leaf-based components.

4. The cat litter additive according to claim 3, wherein the natural antimicrobial substance is made by the steps of:
performing reflux extraction for the fennel and the tinctoria leaves through an extraction solvent to obtain a fennel extract liquid and a tinctoria leaf extract liquid;
allowing the fennel extract liquid and the tinctoria leaf extract liquid to be subjected to filtering, condensing, and freeze drying to powder forms to obtain fennel extract powder and tinctoria leaf extract powder;
dispersing the fennel extract powder and the tinctoria leaf extract powder into distilled water to obtain a fennel extract fraction and a tinctoria leaf extract fraction through an organic solvent;
mixing the fennel extract fraction and the tinctoria leaf extract fraction and applying ultrasonic stimulation to the fennel extract fraction and the tinctoria leaf extract fraction to nanorize the fennel extract fraction and the tinctoria leaf extract fraction; and
applying electrical stimulation to the nanorized fennel extract fraction and tinctoria leaf extract fraction.

5. The cat litter additive according to claim 2, wherein the plant-based natural antimicrobial agent comprises the natural antimicrobial substance and at least one substance selected from sugar alcohol and dextrin.
